(19) United States
(12) Patent Application Publication
(10) Pub. No.: US 2026/0191236 A1
(43) Pub. Date: Jul. 9, 2026

(54) HEATING UNIT, FOOD PRODUCTION METHOD, AND FOOD

(71) Applicant: Sodick Co., Ltd., Kanagawa (JP)

(72) Inventors: Takahiro NAKAMURA, Kanagawa (JP); Akinori NOGUCHI, Kanagawa (JP); Junichi KURITA, Kanagawa (JP); Jotaro TAKANO, Kanagawa (JP)

(73) Assignee: Sodick Co., Ltd., Kanagawa (JP)

(21) Appl. No.: 19/419,153

(22) Filed: Dec. 15, 2025

(30) Foreign Application Priority Data
Jan. 8, 2025 (JP) 2025-002804

(51) Int. Cl. A23L 5/10

(52) U.S. Cl. CPC A23L 5/15

(57) ABSTRACT

A heating unit includes a cylindrical body, a first planar electrode, a second planar electrode, and a conductive thin film, in which the cylindrical body is configured to be fillable with a food having conductivity, the first planar electrode and the second planar electrode are configured to be arrangeable so as to seal the food on two sides of the food filled in the cylindrical body, the conductive thin film is provided in a band shape along a circumferential direction at a position between the first planar electrode and the second planar electrode on an inner circumferential surface of the cylindrical body. The heating unit is configured to heat the food by supplying current into the food from the first planar electrode and the second planar electrode.

### CROSS-REFERENCE TO RELATED APPLICATION

This application claims the priority benefits of Japanese application no. 2025-002804, filed on Jan. 8, 2025. The entirety of the above-mentioned patent application is hereby incorporated by reference herein and made a part of this specification.

### BACKGROUND

### Technical Field

The disclosure relates to a heating unit, a food production method, and food.

### Related Art

Patent Document 1 discloses a technology for joule heating of a ham log filled in an artificial casing while sandwiching it with a pair of electrodes from both outer sides in the longitudinal direction with a predetermined pressure. It is stated that by using joule heating, food can be heated in a short time and can be heated uniformly.

### CITATION LIST

### Patent Document

[Patent Document 1] Japanese Patent No. 4313622

In the case of placing food having conductivity such as meat material between a pair of electrodes and heating the food using joule heating, the outside of the food dissipates heat more easily compared to the inside. In the case of heat dissipation from the outside of the food causing a temperature difference inside the food, the conductivity of high-temperature locations increases, making them easier to heat further, while the conductivity of low-temperature locations relatively decreases, making them harder to heat. As a result, the temperature difference between the outside and inside of the food may expand exponentially. For homogeneous processing, it is important to heat the food as uniformly as possible such that no temperature difference occurs inside the food during joule heating.

The disclosure has been made in view of such circumstances, and provides a heating unit, a food production method, and food that can suppress the occurrence of temperature differences inside the food during joule heating of the food.

### SUMMARY

A heating unit includes a cylindrical body, a first planar electrode, a second planar electrode, and a conductive thin film, in which the cylindrical body is configured to be fillable with a food having conductivity, the first planar electrode and the second planar electrode are configured to be arrangeable so as to seal the food on two sides of the food filled in the cylindrical body, the conductive thin film is provided in a band shape along a circumferential direction at a position between the first planar electrode and the second planar electrode on an inner circumferential surface of the cylindrical body. The heating unit is configured to heat the food by supplying current into the food from the first planar electrode and the second planar electrode.

### BRIEF DESCRIPTION OF THE DRAWINGS

FIG. 1 is a schematic perspective view of a processing device 1 according to an embodiment of the disclosure.

FIG. 2 is a schematic longitudinal cross-sectional view passing through a center of the processing device 1 of FIG. 1.

FIG. 3A is a perspective view showing an example of an arrangement state of a conductive thin film 25 in a heating unit 2, and FIG. 3B is a longitudinal cross-sectional view showing an example of an arrangement state of the conductive thin film 25 in the heating unit 2.

FIG. 4A shows a state in which a first planar electrode 21A and a second planar electrode 21B are positioned in an initial state. FIG. 4B shows a state in which a food 50 is pressurized by the first planar electrode 21A and the second planar electrode 21B. FIG. 4C shows a state in which the food 50 is subjected to joule heating by the first planar electrode 21A and the second planar electrode 21B. FIG. 4D shows a state in which the food 50 is moved to a cooling space 10B by the first planar electrode 21A and the second planar electrode 21B. FIG. 4E shows a state in which the food 50 is conveyed to a discharge position by the first planar electrode 21A and the second planar electrode 21B.

FIG. 5A shows an example of providing a single conductive thin film 25 at a position equidistant from each of a first planar electrode 21A and a second planar electrode 21B. FIG. 5B shows an example of providing one conductive thin film 25 each in a vicinity of the first planar electrode 21A and in a vicinity of the second planar electrode 21B. FIG. 5C shows an example of providing conductive thin films 25 at three locations: a central part between the first planar electrode 21A and the second planar electrode 21B, a vicinity of the first planar electrode 21A, and a vicinity of the second planar electrode 21B.

FIG. 6A shows an arrangement of a joule heating test of Example 1, FIG. 6B shows an arrangement of a joule heating test of Example 2, and FIG. 6C shows an arrangement of a joule heating test of Example 3.

FIG. 7 shows an arrangement of a joule heating test of Example 4.

### DESCRIPTION OF THE EMBODIMENTS

According to the heating unit of the disclosure, in the case of filling food inside a cylindrical body and heating the food using joule heating by a first planar electrode and a second planar electrode, a conductive thin film is arranged on an inner circumferential surface of the cylindrical body that contacts an outside of the food. Since the conductive thin film has a smaller electrical resistance value compared to the food, current flows more easily via the conductive thin film between the first planar electrode and the second planar electrode, and heat generation of the food is promoted along this path. Therefore, heat dissipation amount from the outside of the food is compensated, and generation of temperature difference inside the food is suppressed.

Hereinafter, embodiments of the disclosure will be described. Various features shown in the embodiments described below may be combined with each other. Moreover, an invention is established independently for each feature.

### <Overview of Heating Unit 2>

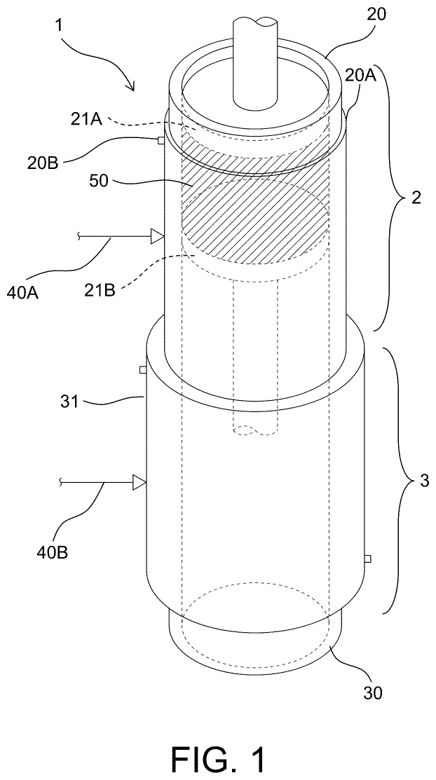

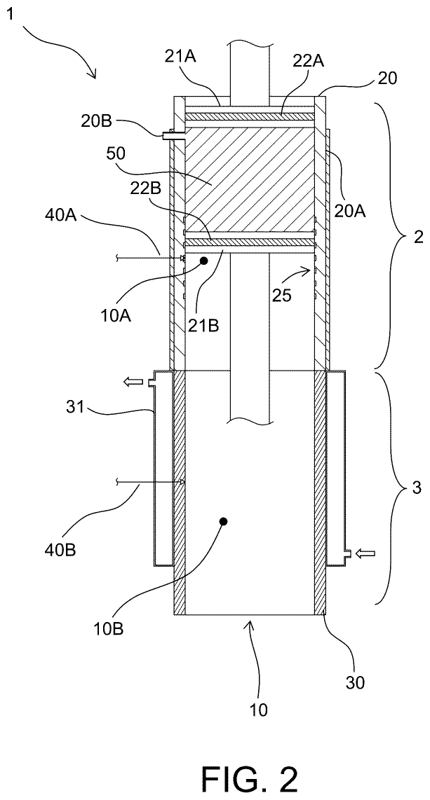

As shown in FIG. 1 and FIG. 2, a processing device 1 includes a heating unit 2 and a cooling unit 3. The heating unit 2 includes a first cylindrical body 20, a first planar electrode 21A, and a second planar electrode 21B. The first cylindrical body 20 is configured to be fillable with a food 50 having conductivity. The first planar electrode 21A and the second planar electrode 21B are each configured to be movable while sliding on an inner circumferential surface of the first cylindrical body 20 along a longitudinal direction of the first cylindrical body 20. In the disclosure, a direction in which the first planar electrode 21A and the second planar electrode 21B slide is defined as the longitudinal direction of the first cylindrical body 20 for the sake of convenience. The first planar electrode 21A and the second planar electrode 21B are configured to be arrangeable so as to seal the food 50 on two sides of the food 50 filled in the first cylindrical body 20. In the heating unit 2, the food 50 is heated by supplying current from the first planar electrode 21A and the second planar electrode 21B into the food 50.

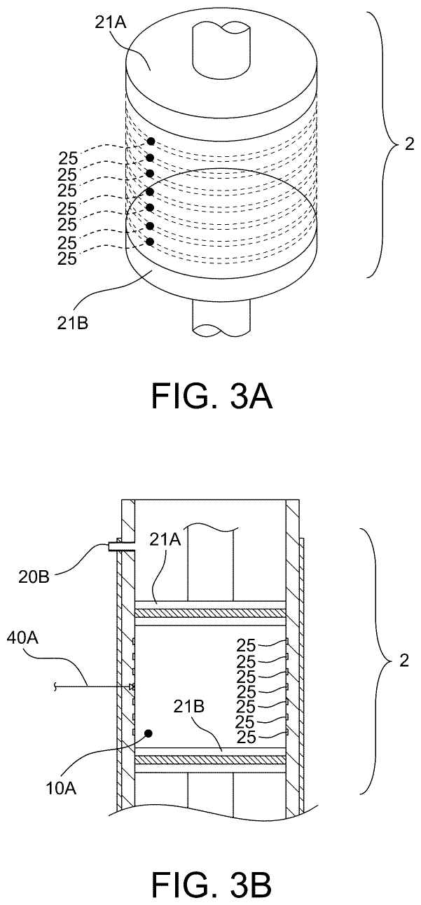

As shown in FIG. 3A and FIG. 3B, the heating unit 2 further includes a conductive thin film 25. The conductive thin film 25 is provided in a band shape along a circumferential direction of the first cylindrical body 20 at a position between the first planar electrode 21A and the second planar electrode 21B on the inner circumferential surface of the first cylindrical body 20. Since the conductive thin film 25 is arranged at a position in contact with the food 50, it is preferable to use metals that are considered appropriate under food sanitation laws, such as iron, aluminum, platinum, and titanium and the like. Here, the conductive thin film 25 has a thickness of about 0.1 mm, and a thin film made of aluminum or titanium is adopted. The aluminum thin film has advantages of being inexpensive and easy to introduce, and having excellent conductivity with a specific resistance of about 2.7 μΩ·cm. The titanium thin film has advantages of excellent durability and strength. The conductivity of titanium is about 42 μΩ·cm, which is about 1/16 of the conductivity of the aluminum thin film. Therefore, for example, in situations other than those requiring durability and strength, and in situations where it is desired to make compensation for heat dissipation amount more gradual than with the aluminum thin film, it is preferable to use the titanium thin film.

In the processing device 1, considering that the first planar electrode 21A and the second planar electrode 21B move while sliding over the arrangement position of the conductive thin film 25, it is preferable that the conductive thin film 25 is arranged at a recessed position on the inner circumferential surface of the first cylindrical body 20 so as to be on the same plane as the inner circumferential surface of the first cylindrical body 20. In the present embodiment, since such a configuration is adopted, the first planar electrode 21A and the second planar electrode 21B are movable while sliding on the inner circumferential surface of the first cylindrical body 20 along the longitudinal direction of the first cylindrical body 20. The first planar electrode 21A and the second planar electrode 21B may pass through the arrangement position of the conductive thin film 25 without any problem. However, the installation method of the conductive thin film 25 is not limited thereto, and in the case of using the conductive thin film 25 with a thickness of 0.1 mm or less, it is also possible to attach it directly without providing a recess on the inner circumferential surface of the first cylindrical body 20.

By providing the conductive thin film 25, current flows more easily along the inner circumferential surface of the first cylindrical body 20 in the case of flowing current with the food 50 sandwiched between the first planar electrode 21A and the second planar electrode 21B. As a result, the vicinity of the conductive thin film 25 in the food 50 becomes more easily heated by joule heating. Therefore, even in the case of the outside of the food 50 dissipating heat, the vicinity of the surface of the food 50 is easily maintained at a temperature similar to that of the inside of the food 50.

It is preferable that the conductive thin film 25 has a width W in the longitudinal direction of the first cylindrical body 20 that is 20% to 70% of a distance L between the first planar electrode 21A and the second planar electrode 21B. The width W is the total width in the case of a plurality of conductive thin films 25. W/L is specifically, for example, 20%, 25%, 30%, 35%, 40%, 45%, 50%, 55%, 60%, 65%, 70%, and may be in a range between any two of the numerical values exemplified here. For example, in the case of the distance between the first planar electrode 21A and the second planar electrode 21B being 150 mm, it is preferable that the conductive thin film 25 has a width of 30 to 105 mm in the longitudinal direction of the first cylindrical body 20. The reason is to prevent current from flowing excessively along the inner circumferential surface of the first cylindrical body 20 and to prevent the outside of the food 50 from being excessively heated.

However, although the food 50 positioned between the first planar electrode 21A and the second planar electrode 21B and the conductive thin film 25 is heated by joule heating, the portion of the food 50 that is in contact with the conductive thin film 25 is hardly subjected to electrical current. Therefore, in the case of arranging a wide conductive thin film 25, the portion of the food 50 that is in contact with the conductive thin film 25 may not be sufficiently heated. For this reason, it is preferable that a plurality of conductive thin films 25 are arranged along the longitudinal direction of the first cylindrical body 20. The number of conductive thin films 25 is, for example, 1 to 20, and preferably 2 to 10. This number is specifically, for example, 1, 2, 3, 4, 5, 6, 7, 8, 9, 10, 11, 12, 13, 14, 15, 16, 17, 18, 19, 20, and may be in a range between any two of the numerical values exemplified here, for example, 3 to 8, 4 to 7.

In the case of an average value of the width of each conductive thin film 25 being Wa, Wa/L is, for example, 1% to 20%, and preferably 3% to 10%. Wa/L is specifically, for example, 1%, 2%, 3%, 4%, 5%, 6%, 7%, 8%, 9%, 10%, 11%, 12%, 13%, 14%, 15%, 16%, 17%, 18%, 19%, 20%, and may be in a range between any two of the numerical values exemplified here. The value of Wa is, for example, 1 mm to 30 mm, and preferably 5 mm to 15 mm. This value is specifically, for example, 1, 3, 5, 10, 15, 20, 25, 30 mm, and may be in a range between any two of the numerical values exemplified here. In the case of a plurality of conductive thin films 25 being arranged with appropriate intervals between each other between the arrangement positions of the first planar electrode 21A and the second planar electrode 21B during heating treatment, it may be expected that the outside of the food 50 is heated more uniformly in the longitudinal direction of the first cylindrical body 20. In the case of the average value of the interval between adjacent conductive thin films 25 being Sa, Sa/Wa is, for example, 0.5 to 10, and preferably 1.0 to 5.0. Sa/Wa is specifically, for example, 0.5, 1.0, 1.5, 2.0, 2.5, 3.0, 3.5, 4.0, 4.5, 5.0, 6.0, 7.0, 8.0, 9.0, 10, and may be in a range between any two of the numerical values exemplified here.

Also, in the case of a standard deviation of the interval between adjacent conductive thin films 25 being Ss, the coefficient of variation determined by Ss/Sa is preferably, for example, 50% or less, and more preferably 30% or less. The value of Ss/Sa is, for example, 0% to 50%, and specifically, for example, 0%, 5%, 10%, 15%, 20%, 25%, 30%, 35%, 40%, 45%, 50%, and may be in a range between any two of the numerical values exemplified here.

The first cylindrical body 20 of the heating unit 2 is preferably made from a material that has a small thermal expansion coefficient, includes pressure resistance at high temperatures, has low thermal conductivity, and excels in electrical insulation properties. By making the first cylindrical body 20 from such a material, it may withstand the saturated steam pressure generated by joule heating of the food 50, and is capable of preventing electrical leakage that may occur during joule heating of the food 50. The first cylindrical body 20 is preferably made from, for example, super engineering plastic having heat resistance such as PEEK (polyetheretherketone). Also, for greater safety, as shown in FIG. 2, it is preferable to adopt a double structure that covers the outside of the first cylindrical body 20 with a metallic outer cover 20A.

Furthermore, a vacuum extraction hole 20B is formed in the heating unit 2, and the heating unit 2 may include a vacuum driving part (not shown) such as a vacuum pump. The vacuum extraction hole 20B may be formed, for example, on the side surface of the first cylindrical body 20. Here, the vacuum extraction hole 20B is formed penetrating through the first cylindrical body 20 and the outer cover 20A. The heating unit 2 is configured to enable vacuum treatment of the inside of a heating space 10A from outside the heating unit 2 via the vacuum extraction hole 20B by the vacuum driving part or the like.

The vacuum extraction hole 20B may be provided at any location as long as vacuum treatment is possible for the food 50 before joule heating. The vacuum driving part may use any component as long as it may perform vacuum treatment as described above.

### <Cooling Unit 3>

The cooling unit 3 includes a second cylindrical body 30 that is continuous with the first cylindrical body 20 of the heating unit 2. The food 50 heated in the heating unit 2 is sent to the cooling unit 3 while being sandwiched between the first planar electrode 21A and the second planar electrode 21B. The cooling unit 3 has a function of cooling the food 50. As shown in FIG. 2, the cooling unit 3 is connected to the heating unit 2 in the up-down direction. An internal space 10 formed by the first cylindrical body 20 and the second cylindrical body 30 is continuous through the heating unit 2 and the cooling unit 3, becoming the heating space 10A in the heating unit 2 and becoming the cooling space 10B in the cooling unit 3.

The second cylindrical body 30 of the cooling unit 3 is preferably made from a material having high thermal conductivity in order to efficiently cool the food 50. The second cylindrical body 30 is preferably made from, for example, metal such as SUS304. Also, the cooling unit 3 preferably includes a jacket part 31 through which a coolant, for example, cold water, may circulate inside. The jacket part 31 makes it possible to cool the food 50 in the cooling space 10B more efficiently.

### <First Planar Electrode 21A and Second Planar Electrode 21B>

The first planar electrode 21A and the second planar electrode 21B are configured to heat the food 50 sandwiched between the first planar electrode 21A and the second planar electrode 21B using joule heating by utilizing voltage applied from a power supply part (not shown). Since the first planar electrode 21A and the second planar electrode 21B contact the food 50, it is preferable to use metals that are considered appropriate under food sanitation laws, such as iron, aluminum, platinum, and titanium. Here, stainless steel or titanium is adopted as the material for the first planar electrode 21A and the second planar electrode 21B.

A heating target object with high conductivity may be heated rapidly and uniformly by heating using joule heating. Normally, the food 50 that is the target of joule heating has high conductivity because an aqueous solution containing electrolytes is mixed therein. The power supply part preferably includes an electronic circuit that capable of supplying alternating current to the electrodes and capable of measuring the impedance of the food 50 sandwiched between the electrodes. The power supply part is preferably configured to be capable of supplying alternating current of up to 10 kHz, for example, according to commands from a voltage control part or the like.

Also, the first planar electrode 21A and the second planar electrode 21B are configured to be movable along the longitudinal direction within the internal space 10 formed by the first cylindrical body 20 and the second cylindrical body 30 in a state where the food 50 is sandwiched therebetween. Specifically, the first planar electrode 21A and the second planar electrode 21B are configured to be movable from the heating space 10A to the cooling space 10B or to the outside of the internal space 10. The first planar electrode 21A and the second planar electrode 21B may be moved by, for example, an air cylinder or the like.

The first planar electrode 21A and the second planar electrode 21B include a seal member 22A and a seal member 22B on their respective outer peripheries. The seal member 22A and the seal member 22B facilitate sealing of the food 50 filled in the first cylindrical body 20 by the first planar electrode 21A and the second planar electrode 21B. Since the first planar electrode 21A and the second planar electrode 21B may form a sealed state as necessary, it becomes possible to appropriately perform vacuum treatment of the food 50 using the vacuum extraction hole 20B, and to prevent moisture content from escaping from the food 50 during joule heating.

It is preferable that the first planar electrode 21A and the second planar electrode 21B have fine irregularities on their respective contact surfaces with the food 50. For example, fine embossing may be performed. With such a configuration, the food 50 may be more securely sandwiched.

### <First Temperature Sensor 40A and Second Temperature Sensor 40B>

The processing device 1 further includes a first temperature sensor 40A and a second temperature sensor 40B. The first temperature sensor 40A is configured to be capable of detecting the surface temperature of the food 50 in the case of being arranged in the heating space 10A. The second temperature sensor 40B is configured to be capable of detecting the surface temperature of the food 50 in the case of being arranged in the cooling space 10B. The first temperature sensor 40A and the second temperature sensor 40B may employ, for example, non-grounded sheath thermocouples.

<Operation of Processing Device 1: Production method of Food 50>

### <Initial State>

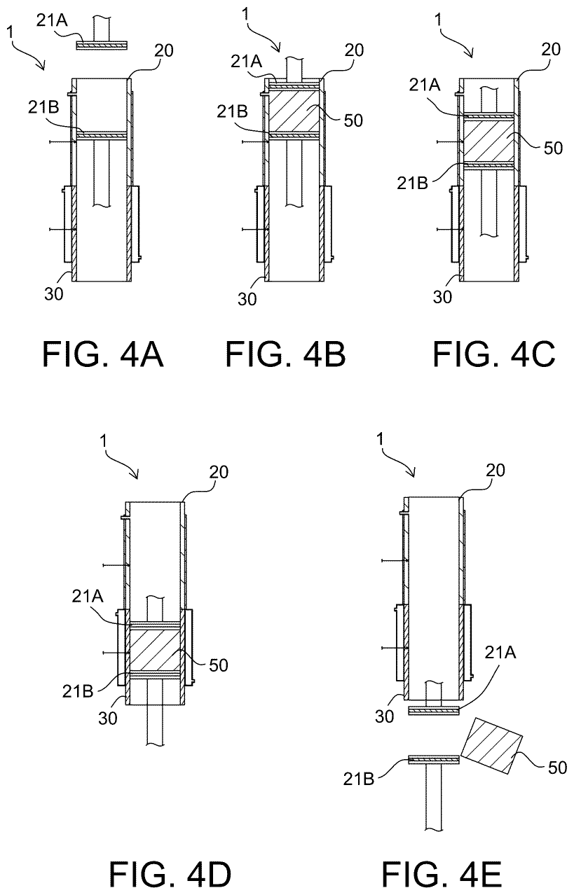

Next, the operation of the processing device 1 will be described with reference to FIG. 4A to FIG. 4E. As shown in FIG. 4A, the initial state is a state in which the first planar electrode 21A is located above the first cylindrical body 20 and the second planar electrode 21B is located in the internal space 10. In the initial state, the food 50 is filled inside the first cylindrical body 20 and between the first planar electrode 21A and the second planar electrode 21B.

### <Sandwiching Step>

Subsequently, as shown in FIG. 4B, the food 50 is sandwiched by the first planar electrode 21A and the second planar electrode 21B. Here, an example is shown in which only the first planar electrode 21A moves downward while the second planar electrode 21B remains fixed, but both the first planar electrode 21A and the second planar electrode 21B may be moved as necessary.

In response to the first planar electrode 21A and the second planar electrode 21B starting to contact the food 50, based on pressure data acquired from a pressure sensor or the like, the first planar electrode 21A and the second planar electrode 21B are moved such that the pressure applied to the protein-containing material becomes a predetermined surface pressure to bring the food 50 into a compacted state. The predetermined surface pressure is specifically 0.5 MPa or less, and preferably 0.3 MPa or less. The predetermined surface pressure is, for example, 0.1 MPa to 0.5 MPa, and specifically, for example, 0.1 MPa, 0.2 MPa, 0.3 MPa, 0.4 MPa, 0.5 MPa, and may be within a range between any two of the numerical values exemplified here. In response to the pressure applied to the food 50 becoming the predetermined surface pressure, the movement of the first planar electrode 21A and the second planar electrode 21B stops. At this time, vacuum treatment may be appropriately performed as necessary.

### <Heating Step>

Subsequently, as shown in FIG. 4C, the first planar electrode 21A and the second planar electrode 21B move to two sides of the arrangement location of the conductive thin film 25 on the inner circumference of the first cylindrical body 20, and heat the food 50 using joule heating. The joule heating treatment preferably uses alternating current of a predetermined frequency. For the predetermined frequency, commercial frequencies of 50 Hz or 60 Hz may be used. For the predetermined frequency, a frequency at which the impedance of the food 50 becomes minimum, or a frequency at which maximum heat generation may be expected including dielectric loss may be used. The joule heating is performed based on temperature data acquired from the first temperature sensor 40A until the temperature of the food 50 reaches a predetermined heating temperature.

Also, the predetermined heating temperature is preferably a temperature equal to or higher than a glass transition point Tg of protein. Protein starts to plasticize at a temperature equal to or higher than the glass transition point Tg, and adjacent proteins undergo thermal fusion with each other. Through thermal fusion of proteins, the strength of the protein-containing material may be further increased, and the texture may be further changed. The glass transition point Tg varies depending on the target material and moisture content, but for protein materials used in the food field, it is 80° C. or higher, and generally 110° C. or higher is particularly common. Also, since protein undergoes hydrolysis and thermal decomposition as it approaches 200° C., it is preferably 200° C. or lower. Therefore, the predetermined heating temperature is 80° C. to 200° C., and preferably 110° C. to 200° C. The predetermined heating temperature is specifically, for example, 80° C., 90° C., 100° C., 110° C., 120° C., 130° C., 140° C., 150° C., 160° C., 170° C., 180° C., 190° C., 200° C., and may be within a range between any two of the numerical values exemplified here.

### <Cooling Step>

In response to the joule heating being stopped, as shown in FIG. 4D, the first planar electrode 21A and the second planar electrode 21B move to the cooling unit 3 while sandwiching the food 50. In the cooling unit 3, the food 50 is cooled to a predetermined cooling temperature. The predetermined cooling temperature is a temperature of 100° C. or lower. The predetermined cooling temperature is, for example, 10° C. to 100° C., and preferably 70° C. to 100° C. The predetermined cooling temperature is specifically, for example, 10° C., 20° C., 30° C., 40° C., 50° C., 60° C., 70° C., 75° C., 80° C., 85° C., 90° C., 95° C., 100° C., and may be within a range between any two of the numerical values exemplified here.

### <Discharge Step>

In response to the temperature data acquired from the second temperature sensor 40B reaching the predetermined cooling temperature, as shown in FIG. 4E, the first planar electrode 21A and the second planar electrode 21B move further down from the cooling unit 3 while sandwiching the food 50, and move to the outside of the processing device 1. In this state, the food 50 that has completed the series of processes may be collected. The collected food 50 is appropriately cut to a desired size and packaged.

As described above, in the processing device 1 of the present embodiment, in the joule heating treatment for the food 50, the presence of the conductive thin film 25 on the inner circumferential surface of the first cylindrical body 20 forms a state in which the surface of the food 50 is easily subjected to joule heating, such that a temperature difference between the surface and the inside of the food 50 is less likely to occur. In particular, even in the case of the food 50 having a large diameter, it becomes possible to uniformly heat by joule heating while preventing the occurrence of a temperature difference in the radial direction.

### <Food 50 Having Conductivity>

The food 50 having conductivity handled in the processing device 1 and the production method of the food 50 according to one embodiment of the disclosure is, for example, a protein-containing material that is any food material containing protein. The protein-containing material specifically refers to a material in which the protein content in the protein-containing material is 1 mass % or more, preferably 10 mass % or more, more preferably 30 mass % or more, and further preferably 50 mass % or more. The protein content in the protein-containing material is, for example, 1 mass % to 100 mass %, and specifically, for example, 1 mass %, 5 mass %, 10 mass %, 15 mass %, 20 mass %, 25 mass %, 30 mass %, 35 mass %, 40 mass %, 45 mass %, 50 mass %, 55 mass %, 60 mass %, 65 mass %, 70 mass %, 75 mass %, 80 mass %, 85 mass %, 90 mass %, 95 mass %, 100 mass %, and may be within a range between any two of the numerical values exemplified here.

In the production method of the food 50 according to one embodiment of the disclosure, an aqueous solution containing electrolytes such as salts is added to and mixed with a dried protein-containing material of any shape to produce a protein-containing material. In the present specification, the protein-containing material before adding and mixing the aqueous solution containing electrolytes is described as a dried protein-containing material. Next, the protein-containing material is subjected to joule heating. Thereby, the dried protein-containing material may be reshaped and quality-converted into a material having a moist and soft texture. Therefore, by using a material poor in processing characteristics such as water solubility and binding properties as the dried protein-containing material, the effects of the disclosure are more exhibited.

The water content of the dried protein-containing material is 50 mass % or less, preferably 30 mass % or less, more preferably 20 mass % or less. The water content of the dried protein-containing material may be substantially 0. The water content of the dried protein-containing material is, for example, 0 mass % to 50 mass %, and specifically, for example, 0 mass %, 1 mass %, 5 mass %, 10 mass %, 15 mass %, 20 mass %, 25 mass %, 30 mass %, 35 mass %, 40 mass %, 45 mass %, 50 mass %, and may be within a range between any two of the numerical values exemplified here.

### OTHER EMBODIMENTS

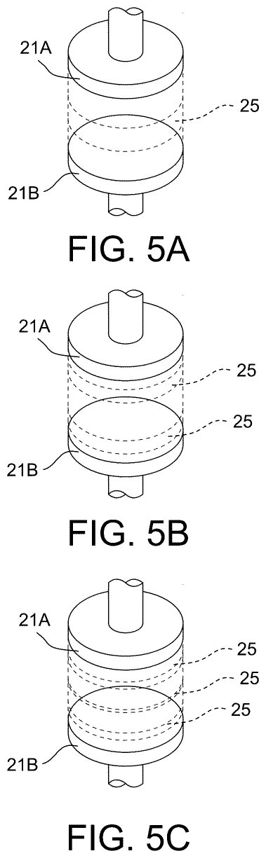

Although an example in which the first planar electrode 21A and the second planar electrode 21B move inside the first cylindrical body 20 has been described, the disclosure may also be applied to a joule heating device in which electrodes are respectively provided at the bottom and top cover of a cylindrical body.
In the above-described embodiment, aluminum or titanium thin films were used as the conductive thin film 25, but if appropriate from the perspective of food sanitation laws and the like, conductive films other than metals, for example, organic conductive films, may be adopted.
In the above-described embodiment, an example in which seven band-shaped conductive thin films 25 are arranged at substantially equal intervals has been shown, but the arrangement of the conductive thin films 25 may be appropriately changed. For example, as shown in FIG. 5A, a configuration may be adopted in which a single conductive thin film 25 is provided at a position equidistant from each of the first planar electrode 21A and the second planar electrode 21B. Also, as shown in FIG. 5B, a configuration may be adopted in which one conductive thin film 25 is provided in each of the vicinity of the first planar electrode 21A and the vicinity of the second planar electrode 21B. Furthermore, as shown in FIG. 5C, a configuration may be adopted in which conductive thin films 25 are provided at three locations: the central part between the first planar electrode 21A and the second planar electrode 21B, the vicinity of the first planar electrode 21A, and the vicinity of the second planar electrode 21B.
The width of the conductive thin film 25 may also be appropriately changed, and in the case of a plurality of conductive thin films 25 being arranged, the respective widths may be made different.

### EXAMPLES

### <Joule Heating Test>

A polypropylene cylindrical container was filled with a cylindrical object to be heated having a diameter of 80 mm and a height of 170 mm, and this object to be heated was sandwiched between the first planar electrode 21A and the second planar electrode 21B for joule heating. The first planar electrode 21A and the second planar electrode 21B are stainless steel electrodes. As the object to be heated, dried gluten to which 50 mmol/L salt water was added to make 50 wt % was used. The conditions for joule heating were 130V and a frequency of 60 Hz.

### Example 1

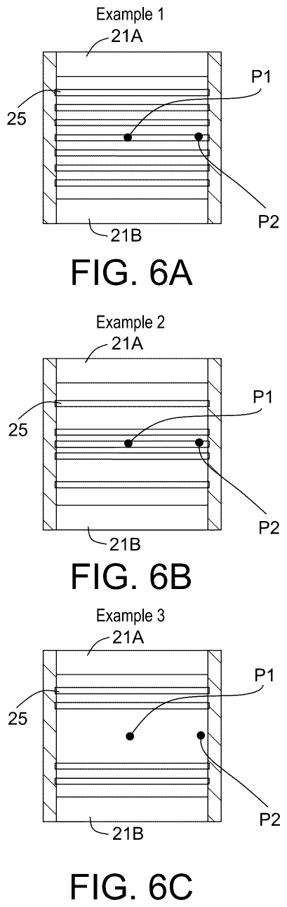

In Example 1, as shown in FIG. 6A, seven aluminum foil tapes having a width of 10 mm and a thickness of 0.08 mm were used as the conductive thin films 25. The distance between the first planar electrode 21A and the conductive thin film 25 at the uppermost position, and the distance between the second planar electrode 21B and the conductive thin film 25 at the lowermost position are each 15 mm. Each conductive thin film 25 was arranged at equal intervals of 10 mm.

### Example 2

In Example 2, as shown in FIG. 6B, five aluminum foil tapes having a width of 10 mm and a thickness of 0.08 mm were used as the conductive thin films 25. The distance between the first planar electrode 21A and the conductive thin film 25 at the uppermost position, and the distance between the second planar electrode 21B and the conductive thin film 25 at the lowermost position are each 15 mm. One conductive thin film 25 was arranged at a central part (75 mm point) equidistant from the first planar electrode 21A and the second planar electrode 21B, and one conductive thin film 25 each was arranged above and below it at 10 mm intervals.

### Example 3

In Example 3, as shown in FIG. 6C, four aluminum foil tapes having a width of 10 mm and a thickness of 0.08 mm were used as the conductive thin films 25. The distance between the first planar electrode 21A and the conductive thin film 25 at the uppermost position is 15 mm, and one conductive thin film 25 was arranged below it with a 10 mm interval. The distance between the second planar electrode 21B and the conductive thin film 25 at the lowermost position is 15 mm, and one conductive thin film 25 was arranged above it with a 10 mm interval.

In Examples 1 to 3, AL-50BT manufactured by 3M Company was used as the aluminum foil tape.

### Comparative Example 1

In Comparative Example 1, no aluminum foil tape was arranged.

The center temperature and side surface temperature of the object to be heated were detected at positions P1 and P2 in FIG. 6A to FIG. 6C, respectively. The object to be heated was heated by joule heating until the center temperature reached 130° C. Table 1 shows the detected values of the side surface temperature in the case of the center temperature reaching 130° C. in each Example and Comparative Example. For measurement, a non-grounded sheath thermocouple S1K10X150-A2X5C manufactured by Toho Electronics Co., Ltd. was used.

TABLE 1

| | Center | Side surface |
|---|---|---|
| | temperature | temperature |
| | (° C.) | (° C.) |
| Example 1 | 130 | 128 |
| Example 2 | 130 | 120 |
| Example 3 | 130 | 136 |
| Comparative Example 1 | 130 | 75 |

In Comparative Example 1 in which no aluminum foil tape was arranged, the temperature difference between the center temperature and the side surface temperature was 55° C. In contrast, in Example 1, the temperature difference was 2° C., in Example 2, the temperature difference was 10° C., and in Example 3, the temperature difference was 6° C., confirming that the temperature difference was suppressed compared to Comparative Example 1.

The same joule heating test was performed using a titanium conductive thin film 25.

### Example 4

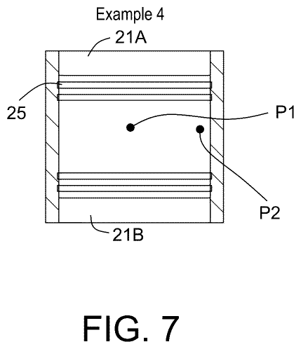

In Example 4, as shown in FIG. 7A, four plate sheet foils manufactured by XMRISE titanium, each having a width of 10 mm and a thickness of 0.1 mm was used as the conductive thin film 25. One conductive thin film 25 was arranged at a position 10 mm from the first planar electrode 21A, and another conductive thin film 25 was arranged with a further 10 mm interval. Similarly for the lower side, one conductive thin film 25 was arranged at a position 10 mm from the second planar electrode 21B, and another conductive thin film 25 was arranged with a further 10 mm interval.

The center temperature and the side surface temperature of the object to be heated were detected at positions P1 and P2 in FIG. 7, respectively. The object to be heated was heated by joule heating until the center temperature reached 130° C. Table 2 shows the detected values of the side surface temperature in the case of the center temperature of the object to be heated reaching 130° C. in each Example and Comparative Example. For measurement, a non-grounded sheath thermocouple S1K10X150-A2X5C manufactured by Toho Electronics Co., Ltd. was used.

TABLE 2

| | Center | Side surface |
|---|---|---|
| | temperature | temperature |
| | (° C.) | (° C.) |
| Example 4 | 131 | 125 |

In Example 4 using titanium plates, the temperature difference was 6° C., and it was confirmed that the temperature difference was suppressed similarly to Examples 1 to 3 using aluminum foil tape.

### INDUSTRIAL APPLICABILITY

As an example of the above-described dried protein-containing material, meat substitute material may be mentioned. In recent years, with the increase in protein demand due to the increase in world population and meat consumption, the development of materials manufactured from agricultural product-derived proteins as meat substitute foods has become active.

Such meat substitute materials often use defatted soybean as a raw material. Generally, defatted soybean has lost processing characteristics such as water solubility and binding properties due to heat treatment and organic solvent treatment during the defatting process. Therefore, materials that have been converted into expanded and dried materials from materials that have lost processing characteristics through extrusion processing methods, enabling processing such as water rehydration softening and seasoning, are distributed in the market.

However, meat substitute materials still have problems such as inferior texture compared to meat, difficulty in manufacturing in various sizes (particularly large shapes), and requiring time and effort for cooking and processing. By producing food 50 using the processing device 1, such meat substitute materials may be quality-converted into integrated food 50 with moist texture.

The dried protein-containing material may be dried foods such as jerky or dried squid, in addition to meat substitute materials. These may also be quality-converted into integrated food 50 with moist texture by the production method of food 50 using the processing device 1.

What is claimed is:

1. A heating unit, comprising: a cylindrical body, a first planar electrode, a second planar electrode, and a conductive thin film,
wherein the cylindrical body is configured to be fillable with a food having conductivity,
the first planar electrode and the second planar electrode are configured to be arrangeable so as to seal the food on two sides of the food filled in the cylindrical body,
the conductive thin film is provided in a band shape along a circumferential direction at a position between the first planar electrode and the second planar electrode on an inner circumferential surface of the cylindrical body, and
wherein the heating unit is configured to heat the food by supplying current into the food from the first planar electrode and the second planar electrode.

2. The heating unit according to claim 1,
wherein the conductive thin film has a width in a longitudinal direction of the cylindrical body that is 20% to 70% of a distance between the first planar electrode and the second planar electrode.

3. The heating unit according to claim 1,
wherein a plurality of the conductive thin films are arranged in a longitudinal direction of the cylindrical body.

4. The heating unit according to claim 3,
wherein the plurality of arranged conductive thin films have an average value of a width in the longitudinal direction of the cylindrical body that is 1% to 20% of a distance between the first planar electrode and the second planar electrode.

5. The heating unit according to claim 3,
wherein a value obtained by dividing an average value of intervals between adjacent conductive thin films by an average value of widths in the longitudinal direction of the cylindrical body of the plurality of arranged conductive thin films is 0.5 to 10.

6. The heating unit according to claim 3,
wherein a coefficient of variation obtained by dividing a standard deviation of intervals between adjacent conductive thin films by the intervals between the adjacent conductive thin films is 0% to 50%.

7. The heating unit according to claim 1,
wherein the first planar electrode and the second planar electrode are configured to be movable while sliding on the inner circumferential surface of the cylindrical body along a longitudinal direction of the cylindrical body, and are configured to be capable of passing through an arrangement position of the conductive thin film.

8. A food production method using the heating unit according to claim 1, the method comprising: a sandwiching step and a heating step,
wherein in the sandwiching step, a food having conductivity made of protein-containing material is put into a heating space inside the cylindrical body, and the food is sandwiched between the first planar electrode and the second planar electrode; and
in the heating step, the first planar electrode and the second planar electrode respectively move to positions on two sides of the conductive thin film in a longitudinal direction of the cylindrical body while sandwiching the food, and heat the food sandwiched in the sandwiching step using joule heating to a predetermined heating temperature.

9. A food produced by the food production method according to claim 8.
